(19) United States
(12) Patent Application Publication
(10) Pub. No.: US 2025/0365450 A1
(43) Pub. Date: Nov. 27, 2025

(54) ENCODING DEVICE, DECODING DEVICE, AND NON-TRANSITORY MACHINE-READABLE MEDIUM FOR CODING VIDEO DATA

(71) Applicant: SHARP KABUSHIKI KAISHA, Sakai City (JP)

(72) Inventors: YU-CHIAO YANG, New Taipei City (TW); YI-Hao Lin, New Taipei City (TW)

(21) Appl. No.: 19/217,372

(22) Filed: May 23, 2025

Related U.S. Application Data
(60) Provisional application No. 63/651,558, filed on May 24, 2024.

(51) Int. Cl. H04N 19/88; H04N 19/107; H04N 19/176; H04N 19/186

(52) U.S. Cl. CPC H04N 19/88; H04N 19/107; H04N 19/176; H04N 19/186

(57) ABSTRACT

An electronic device for decoding/encoding video data is provided. The electronic device includes at least one processor and at least one non-transitory computer-readable medium coupled to the at least one processor and storing one or more computer-executable instructions that, when executed by the at least one processor, cause the electronic device to: receive the video data; determine a chroma block from an image frame according to the video data; construct, for the chroma block, a candidate list including multiple prediction modes; generate a reordered candidate list based on the candidate list using multiple cost metrics; determine a chroma prediction for the chroma block based on the reordered candidate list; and reconstruct the chroma block based on the chroma prediction. In addition, a non-transitory machine-readable medium for coding video data is also provided.

### CROSS-REFERENCE TO RELATED APPLICATION(S)

The present disclosure claims the benefit of and priority to U.S. Provisional Patent Application Ser. No. 63/651,558, filed on May 24, 2024, entitled “COST METRIC SELECTION ON CHROMA MODE REORDERING,” the content of which is hereby incorporated herein fully by reference in its entirety into the present disclosure for all purposes.

### FIELD

The present disclosure is generally related to video coding and, more specifically, to techniques for reordering a candidate list for chroma predictions.

### BACKGROUND

Video coding technologies are widely used to enable the efficient transmission and storage of visual content across various platforms and networks. To achieve high compression efficiency, coding systems apply a range of prediction, transformation, and quantization techniques that reduce spatial and temporal redundancies present in video data. During the encoding process, different prediction candidates may be generated to represent blocks of image data while minimizing coding cost. These candidates can be evaluated based on various factors that affect coding performance, including accuracy in representing source data, processing complexity, and compatibility with coding structures. The evaluation process plays a role in determining which prediction candidates are ultimately used during encoding and decoding.

As video coding standards continue to evolve to support higher resolutions, increased frame rates, and lower bitrates, ongoing improvements are sought in the techniques used to assess prediction performance and make selection decisions. Such improvements are important for enabling more accurate prediction, better compression efficiency, and higher quality reconstruction in modern video coding systems.

### SUMMARY

The present disclosure is directed to a device and method for reordering a candidate list for chroma predictions, aimed at improving prediction accuracy and enhancing coding efficiency in video decoding.

In a first aspect of the present disclosure, an electronic device for decoding video data is provided. The electronic device includes at least one processor, and at least one non-transitory computer-readable medium coupled to the at least one processor and storing one or more computer-executable instructions. The one or more computer-executable instructions, when executed by the at least one processor, cause the electronic device to: receive the video data; determine a chroma block from an image frame according to the video data; construct a candidate list for the chroma block, the candidate list including multiple prediction modes; generate at least one reordered candidate list based on the candidate list by: calculating, for each of the prediction modes in the candidate list, multiple template costs by using multiple cost metrics, to obtain multiple cost instances each corresponding to one of the prediction modes and one of the cost metrics, and including and sorting the cost instances in the at least one reordered candidate list; determine a chroma prediction for the chroma block based on the at least one reordered candidate list; and reconstruct the chroma block based on the chroma prediction.

In an implementation of the first aspect, the one or more computer-executable instructions, when executed by the at least one processor, further cause the electronic device to: determine a selected cost metric from the cost metrics; and determine the chroma prediction for the chroma block further based on the selected cost metric.

In another implementation of the first aspect, the cost metrics include one or more of a sum of absolute difference (SAD), a sum of absolute transformed difference (SATD), a mean removed SAD (MR-SAD), a sum of squared difference (SSD), a structural similarity (SSIM), a mean absolute difference (MAD), and a mean squared difference (MSD).

In another implementation of the first aspect, the candidate list includes at least one of a decode derived cross-component prediction (DDCCP) mode and a cross-component prediction (CCP) merge mode.

In another implementation of the first aspect, the candidate list includes a most probable mode (MPM) list.

In a second aspect of the present disclosure, an electronic device for encoding video data is provided. The electronic device includes at least one processor, and at least one non-transitory computer-readable medium coupled to the at least one processor and storing one or more computer-executable instructions. The one or more computer-executable instructions, when executed by the at least one processor, cause the electronic device to: receive the video data; determine a chroma block from an image frame according to the video data; construct a candidate list for the chroma block, the candidate list including multiple prediction modes; generate at least one reordered candidate list based on the candidate list by: calculating, for each of the prediction modes in the candidate list, multiple template costs by using multiple cost metrics, to obtain multiple cost instances each corresponding to one of the prediction modes and one of the cost metrics, and including and sorting the cost instances in the at least one reordered candidate list; determine a chroma prediction for the chroma block based on the at least one reordered candidate list; and reconstruct the chroma block based on the chroma prediction.

In an implementation of the second aspect, the one or more computer-executable instructions, when executed by the at least one processor, further cause the electronic device to: determine a selected cost metric from the cost metrics; and determine the chroma prediction for the chroma block further based on the selected cost metric.

In another implementation of the second aspect, the cost metrics include one or more of an SAD, an SATD, an MR-SAD, an SSD, an SSIM, an MAD, and an MSD.

In another implementation of the second aspect, the candidate list includes at least one of a DDCCP mode and a CCP merge mode.

In another implementation of the second aspect, the candidate list includes an MPM list.

In a third aspect of the present disclosure, non-transitory machine-readable medium of an electronic device storing one or more computer-executable instructions for decoding video data is provided. The one or more computer-executable instructions, when executed by at least one processor of the electronic device, cause the electronic device to: receive the video data; determine a chroma block from an image frame according to the video data; construct a candidate list for the chroma block, the candidate list including multiple prediction modes; generate at least one reordered candidate list based on the candidate list by: calculating, for each of the prediction modes in the candidate list, multiple template costs by using multiple cost metrics, to obtain multiple cost instances each corresponding to one of the prediction modes and one of the cost metrics, and including and sorting the cost instances in the at least one reordered candidate list; determine a chroma prediction for the chroma block based on the at least one reordered candidate list; and reconstruct the chroma block based on the chroma prediction.

In an implementation of the third aspect, the one or more computer-executable instructions, when executed by the at least one processor, further cause the electronic device to: determine a selected cost metric from the cost metrics; and determine the chroma prediction for the chroma block further based on the selected cost metric.

In another implementation of the third aspect, the cost metrics include one or more of an SAD, an SATD, an MR-SAD, an SSD, an SSIM, an MAD, and an MSD.

In another implementation of the third aspect, the candidate list includes at least one of a DDCCP mode and a CCP merge mode.

In another implementation of the third aspect, the candidate list includes an MPM list.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIG. 4 is a schematic diagram illustrating a collated luma block and a chroma block, in accordance with one or more example implementations of this disclosure.

FIG. 5 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The present disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

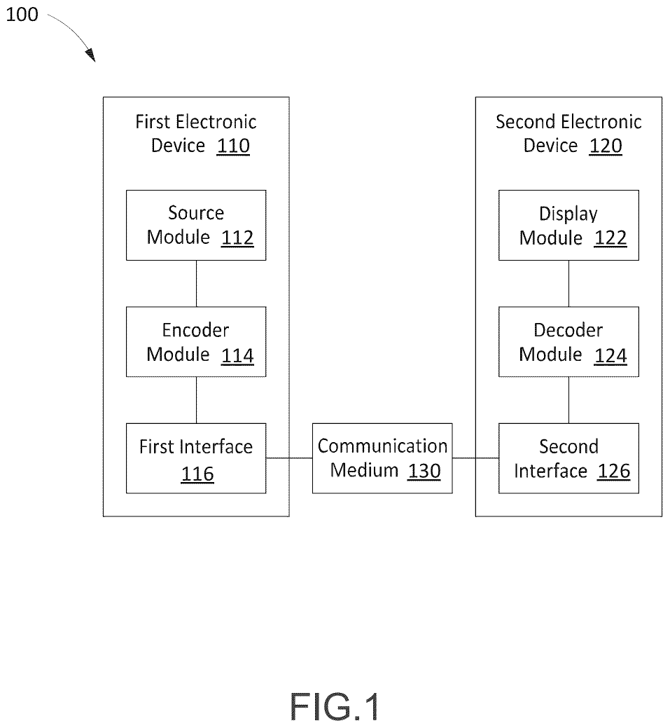

FIG. 1 is a block diagram illustrating a system 100 having a first electronic device and a second electronic device for encoding and decoding video data, in accordance with one or more example implementations of this disclosure.

The system 100 includes a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

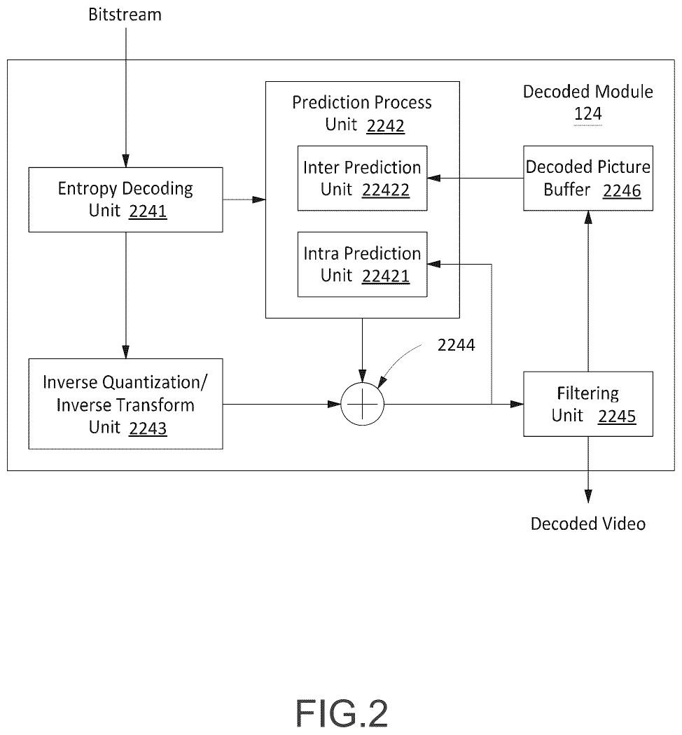

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components is reconstructed by the prediction processing unit 2242.

The intra prediction unit 22421 may reconstruct multiple chroma components of the current block unit based on the multiple luma components of the current block unit when the multiple luma components of the current block unit is reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block.

The motion vector may indicate a displacement of the current block unit within the current image block relative to a reference block unit within the reference image block. The reference block unit may be a block determined to closely match the current block unit.

The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (which are not explicitly illustrated for the brevity of description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

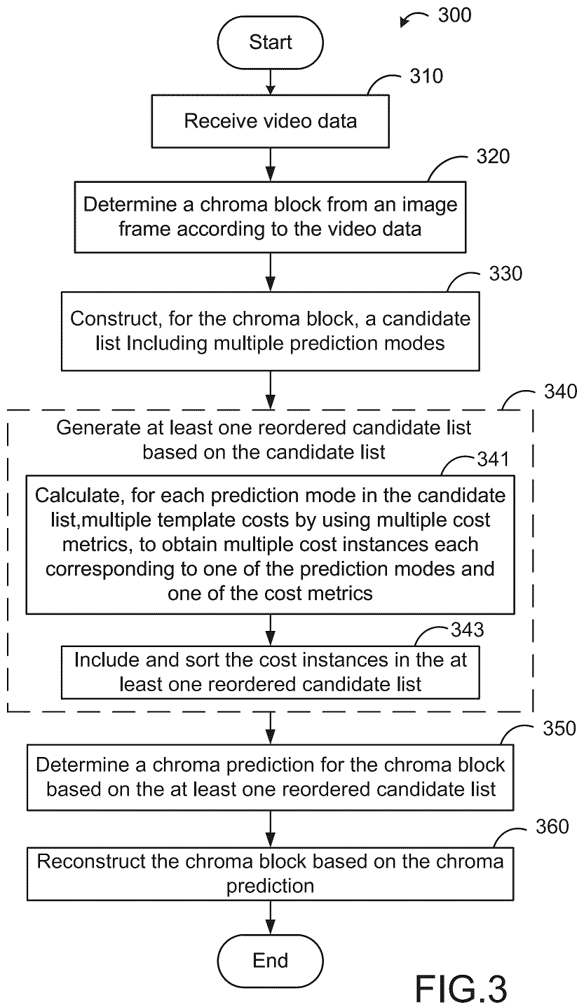

FIG. 3 is a flowchart illustrating a method/process 300 for decoding and/or encoding video data by an electronic device, in accordance with one or more example implementations of this disclosure. The method/process 300 is an example implementation, as there may be a variety of methods of decoding the video data.

The method/process 300 may be performed by an electronic device, such as the electronic device 110 or electronic device 120, using the configurations illustrated in FIGS. 1 and 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus may be different from what is illustrated. Additional blocks may be added or fewer blocks may be utilized without departing from the scope of the present disclosure.

At block 310, the method/process 300 may start by receiving (e.g., by the decoder module 124) the video data. The video data received by the decoder module 124 may include a bitstream provided by the encoder module 114, which may include information of multiple image frames.

With reference to FIG. 1 and FIG. 2, the second electronic device 120 may receive the bitstream from an encoder, such as the first electronic device 110, or from other video providers, via the second interface 126. The second interface 126 may provide the bitstream to the decoder module 124.

The entropy decoding unit 2241 may decode the bitstream to determine multiple prediction indications and multiple partitioning indications for multiple video images. Then, the decoder module 124 may further reconstruct the multiple video images based on the prediction indications and the partitioning indications. The prediction indications and the partitioning indications may include multiple flags and multiple indices.

At block 320, the method/process 300 may determine (e.g., by the decoder module 124), a chroma (e.g., chrominance) block from an image frame according to the video data. Specifically, the video data may include the bitstream received from the encoder, and a block unit (e.g., a chrome block) may be determined from an image frame according to the bitstream.

With reference to FIG. 1 and FIG. 2, the decoder module 124 may determine the image frames based on the bitstream and may divide each image frame to determine the block units according to the partition indications in the bitstream. For example, the decoder module 124 may divide the image frames to generate multiple CTUs, and further divide one of the CTUs to determine the block units according to the partition indications based on any video coding standard.

In some implementations, the block unit may be a current block. For example, the current block may include at least one of a coding unit, a prediction unit, a macroblock, a luma block, and a chrome block. For example, the current block may be a current chroma block.

At block 330, the method/process 300 may construct a candidate list for the (current) chrome block. Specifically, the candidate list may be a chroma candidate list and may include multiple prediction modes. The prediction modes included in the chroma candidate list may also be referred to as chroma prediction modes, or chroma modes.

In some implementations, the (echroma) candidate list may be constructed by including at least one of the conventional angular mode(s), such as angular modes 2 to 66, as used in Versatile Video Coding (VVC) or Enhanced Compression Model (ECM), or angular modes 2 to 34, as used in High Efficiency Video Coding (HEVC). In some implementations, the (chroma) candidate list may be constructed by including at least one of the conventional non-angular mode(s), such as a Direct Current (DC) mode or a Planar mode.

In some implementations, the (chroma) candidate list may be constructed by including at least one of the conventional angular mode(s) and conventional non-angular mode(s). For example, the (chroma) candidate list may include the planar mode, a vertical (VER) mode, a horizontal (HOR) mode, the DC mode, a Cross-Component Linear Model Left-Top (CCLM_LT) mode, a Cross-Component Linear Model Left (CCLM_L) mode, a Cross-Component Linear Model Top (CCLM_T) mode, and a Derived Mode (DM), where the VER mode and the HOR mode are conventional angular modes, and the planar mode, the DC mode, the CCLM_LT mode, the CCLM_L mode, the CCLM_T mode, and the DM are conventional non-angular modes.

In some implementations, the (chroma) candidate list may be constructed using method(s) defined in the VVC or ECM.

In some implementations, the (chroma) candidate list may be constructed by including non-linear model mode(s) and/or linear model mode(s). The linear model mode(s) may include Cross-Component Prediction (CCP) modes. The non-linear model mode(s) may include at least one of a chroma Derived Block Vector (DBV) mode, the DM, a Decoder-side Intra Mode Derivation (DIMD) mode for chroma (DIMD chroma), the planar mode, the DC mode, the VER mode, and/or the HOR mode. In some implementations, the chroma mode(s) for predicting the current block (e.g., the current chroma block) may be determined from the non-linear model mode(s) (e.g., defined in ECM) when the linear mode flag is equal to 0.

In some implementations, the chroma DBV mode may use a block vector (e.g., which may be obtained from at least an Intra Template Matching Prediction (intraTMP)-coded block or an Intra Block Copy (IBC)-coded block) to determine a chroma reference block for predicting the current block (e.g., the current chroma block). The intraTMP-coded block and IBC-coded block may be a luma block or a reconstructed chroma block. In some implementations, the DM may predict the current block (e.g., the current chroma block) based on the mode of a corresponding luma block. In some implementations, the DIMD chroma may derive a Histogram of Gradients (HoG) to predict the current block (e.g., the current chroma block).

In some implementations, the (chroma) candidate list may be constructed based solely on non-linear model mode(s). For example, the (chroma) candidate list may include the chroma DBV mode, the DM, the DIMD chroma, and four default modes (e.g., the planar mode, the HOR mode, the VER mode, and the DC mode).

In some implementations, candidate(s) in the (chroma) candidate list may be obtained based on a collocated luma block, with respect to the current block (e.g., the current chroma block). For example, a mode derived from a Template-based Intra Mode Derivation (TIMD)-coded luma block may be included in the (chroma) candidate list. It should be noted that the collocated luma block may be coded by mode(s) other than the TIMD mode, such as a Spatial Geometric Partitioning Mode (Spatial GPM). It should be also noted that the candidate(s) in the candidate list may include the prediction mode(s) included in the candidate list.

In some implementations, candidate(s) in the (chroma) candidate list may be obtained based on a reconstructed chroma block. For example, a neighboring chroma block, which is reconstructed prior to the current block (e.g., the current chroma block), based on a specific chroma mode, and the specific chroma mode may be included in the (chroma) candidate list. The neighboring (e.g., reconstructed) chroma block may be located at top-left, top, top-right, left, or bottom-left, relative to the current block (e.g., the current chroma block), with relative coordinate positions of (−1, −1), (block width −1, −1), (block width, −1), (−1, block height −1), or (−1, block height), respectively. That is, the block width and the block height of the neighboring chroma block may be used to determine the relative coordinate position(s).

In some implementations, the (chroma) candidate list may be constructed by sequentially including the DM, the DIMD chroma, the planar mode, the DC mode, the HOR mode, the VER mode, mode(s) obtained from the collocated luma block, mode(s) obtained from the neighboring reconstructed chroma block, and at least one DBV mode for chroma block(s).

In some implementations, a linear model mode may be a single linear model mode or a multi-linear model mode. For example, a Convolutional Cross-Component Model (CCCM) mode may be a single model mode, and a Multi-Model CCCM (MM-CCCM) mode may be a multi-model mode. Other linear model modes may be deduced similarly to have single model mode or multiple model mode.

In some implementations, the linear model mode(s) may include at least one mode of Cross-Component Linear Model (CCLM), Multi-Model Linear Model (MMLM), CCCM, Block Vector Guided CCCM (BVG-CCCM), Gradient Linear Model (GLM), Frequency Linear Model (FLM), Decoder-side Derived Cross-Component Prediction (DDCCP), Gradient-based Local CCCM (GLCCCM), or Cross-Component Prediction (CCP) merge. The CCP merge mode may include non-adjacent candidate(s), and may be referred to as a non-local CCP.

A linear model may be determined based on reconstructed sample(s) neighboring the current block (e.g., the current chroma block). For example, a prediction mode using a linear model determined based on top reconstructed sample(s) and left reconstructed sample(s) may be referred to as a Left-Top (LT) mode; a prediction mode using a linear model determined based solely on top reconstructed sample(s) may be referred to as a Top (T) mode; and a prediction mode using a linear model determined based solely on left reconstructed sample(s) may be referred to as a Left (L) mode. The reconstructed sample(s) may include reconstructed luma sample(s) neighboring the collocated luma block, collocated with the current chroma block.

In some implementations, CCLM mode(s) may include the CCLM_LT mode, the CCLM_L mode, and the CCLM_T mode. In some implementations, Multi-Model Linear Model (MMLM) mode(s) may include an MMLM Left-Top (MMLM_LT) mode, an MMLM Left (MMLM_L) mode, and an MMLM Top (MMLM_T) mode. Other linear models may be deduced similarly to have LT, T, and/or L mode(s). Each linear model may be derived based on different reconstruction region(s), and the size(s) of the reconstruction region(s) may differ. For example, the linear model of the CCLM_LT mode may be derived based on a first reconstruction region, and the linear model of the CCCM_T mode may be derived based on a second reconstruction region, where the size of the first reconstruction region may differ from the size of the second reconstruction region.

In some implementations, a linear model may be adjusted based on the slope adjustment technique defined in the ECM.

In some implementations, the (chroma) candidate list may be constructed based solely on linear model mode(s). For example, the (chroma) candidate list may include modes of CCLM, CCCM, MM-CCCM, GLCCCM, CCCM applied with Local Block-based CCP (LBCCP), and MM-CCCM applied with LBCCP.

In some implementations, the (chroma) candidate list may be determined based on at least one luma position(s), chroma neighboring position(s), and/or reconstruction region(s).

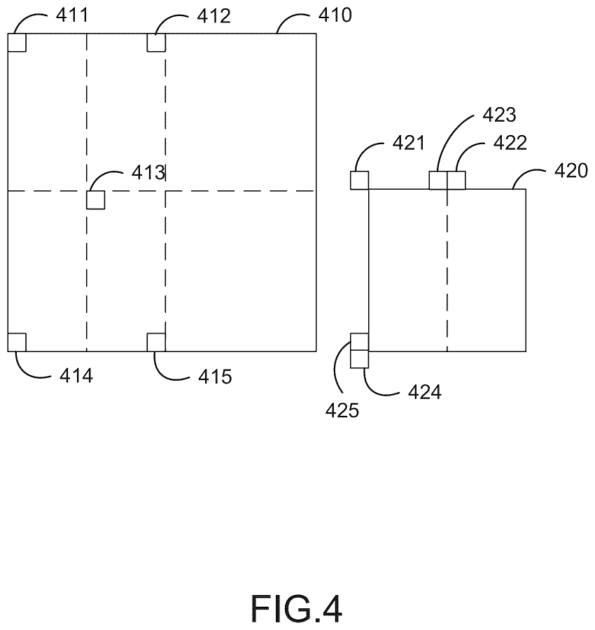

FIG. 4 is a schematic diagram illustrating a chroma block and a collated luma block, in accordance with one or more example implementations of this disclosure. Referring to FIG. 4, a collocated luma block 410 may be collocated with a chroma block 420 (e.g., the current chroma block).

Referring to FIG. 4, in some implementations, at least one candidate in the (chroma) candidate list for the (current) chroma block 420 may be determined based on at least one of the luma positions of the collocated luma block 410, and the luma position(s) may include a top-left position 411, a top-right position 412, a center position 413, a bottom-left position 414, and a bottom-right position 415. The (current) chroma block 410 may inherit the luma information from the luma position(s). For example, the luma information may include mode information, such as a luma mode index, or a block vector from a luma block coded in the Intra Template Matching Prediction (intraTMP) mode or the Intra Block Copy (IBC) mode. The luma information may be made available to chroma block(s) via a specific conversion, such as scaling the block vector or quantizing the mode index.

Referring to FIG. 4, in some implementations, at least one candidate in the (chroma) candidate list for the (current) chroma block 420 may be determined based on at least one of the chroma neighboring position(s). The chroma prediction mode of (one of) the chroma neighboring position(s) may be included in the (chroma) candidate list. The chroma neighboring position(s) may include a top-left position 421, a top-right position 422, a top position 423, a bottom-left position 424, and a left position 425.

It should be noted that, the luma position(s) and the chroma neighboring position(s) are not limited to what is illustrated with FIG. 4. For example, the luma position(s) may extend beyond the collocated luma block 410. The number of luma position(s) may be reduced or increased. The chroma neighboring position(s) may extend to include non-adjacent position(s) that, for example, are not adjacent to the (current) chroma block 410.

In some implementations, at least one candidate in the (chroma) candidate list may be determined based on the reconstruction region(s). For example, a linear model may be derived based on a luma reconstruction region and a chroma reconstruction region, and the linear model may be used to obtain a prediction mode (e.g., a linear model mode) for being included in the chroma candidate list, as a candidate. For example, a non-linear model mode such as the DIMD chroma mode may be derived based on a reconstructed luma region and may be used as a candidate in the chroma candidate list.

In some implementations, the (chroma) candidate list may include at least one of the DDCCP mode and the CCP merge mode. In some implementations, the (chroma) candidate list may include a most probable mode (MPM) list.

Returning to FIG. 3, at block 340, the method/process 300 may generate (e.g., by the decoder module 124) at least one reordered candidate list based on the candidate list. Specifically, the prediction modes in the candidate list may be reordered by using multiple (e.g., at least two) cost metrics. More specifically, block 340 may include block 341 and block 343 for generating the at least one reordered candidate list.

In some implementations, only one reordered candidate list may be generated. That is, the at least one reordered candidate may include only one reordered candidate list.

In some implementations, each cost metric may be used for generating one reordered candidate list. Therefore, the number of generated reordered candidate lists may be equal to the number of used cost metrics. For example, a first reordered candidate list may be generated based on a first cost metric and a second reordered candidate list may be generated based on a second cost metric (e.g., that is different from the first cost metric).

In some implementations, the used cost metrics may include one or more of a sum of absolute difference (SAD), a sum of absolute transformed difference (SATD), a mean removed SAD (MR-SAD), a sum of squared difference (SSD), a structural similarity (SSIM), a mean absolute difference (MAD), and a mean squared difference (MSD).

As indicated in FIG. 3, generating the at least one reordered candidate list may include operations 341 and 343. At block 341, the method/process 300 may calculate (e.g., by the decoder module 124), for each prediction mode in the candidate list multiple template costs by using multiple cost metrics to obtain multiple cost instances. Each cost instance may correspond to one of the prediction modes in the candidate list and one of the used cost metrics.

In some implementations, for each prediction mode in the candidate list, the decoder module 124 may perform template matching at least two times, each time based on one cost metric, which may result in obtaining at least two template costs. Each of the template costs may correspond to a prediction mode and a cost metric, and thus, may be recorded as a cost instance. Therefore, at least two cost instances may be obtained for one prediction mode, where each cost instance may correspond to a used cost metric. In a case that there are n prediction modes included in the candidate list and m cost metrics are used for template matching, n*m cost instances may be obtained, where each cost instance may correspond to a prediction mode and a cost metric.

In some implementations, performing the template matching (e.g., for intra prediction) may include determining a reconstructed template region adjacent to the current block, typically using already decoded pixels from the left and above. For each prediction mode in the candidate list, predicted pixels may be generated for the template region and compared to the actual reconstructed pixels using a cost metric, to obtain a corresponding template cost.

For example, for a first prediction mode A in the candidate list, the decoder module 124 may perform a first template matching based on a first cost metric M to obtain a first template cost X, and perform a second template matching based on a second cost metric N to obtain a second template cost Y, and as such, a first cost instance (A, M, X) and a second cost instance (A, N, Y) may be obtained. Also, for a second prediction mode B in the candidate list, the decoder module 124 may perform a third template matching based on the first cost metric M to obtain a third template cost X′, and perform a fourth template matching based on the second cost metric N to obtain a fourth template cost Y′, and as such, a third cost instance (B, M, X′) and a fourth cost instance (B, N, Y′) may be obtained.

In some implementations, a flag or an index may be signaled in the video data to indicate the cost metric(s) used for generating the reordered candidate list. The flag or the index may be, for example, signaled at a high-level syntax structure (e.g., VPS, SPS, VPS) or a picture/slice level (e.g., picture header, slice header).

At block 343, the method/process 300 may include and sort (e.g., by the decoder module 124), the cost instances in the at least one reordered candidate list.

In some implementations, the cost instances may be included in one reordered candidate list and may be sorted based on the cost value (e.g., template cost) associated with each cost instance. Specifically, the cost instances may be included and organized into the candidate list that is sorted in a descending or ascending order. For example, multiple cost instances (A, M, X), (A, N, Y), (B, M, X′) and (B, N, Y′) may be obtained using multiple cost metrics M, N, and the cost instances (A, M, X), (A, N, Y), (B, M, X′) and (B, N, Y′) may then be included and sorted into a reordered candidate list, such as (B, M, X′), (A, N, Y), (A, M, X), and (B, N, Y′), in a case where X′<Y<X<Y′.

In some implementations, each cost metric may be used to generate a respective reordered candidate list. Within each reordered candidate list, the corresponding cost instances may be sorted based on the cost value (e.g., a template cost) associated with each cost instance. The sorting may be performed in an ascending or descending order. For example, multiple cost instances (A, M, X), (A, N, Y), (B, M, X′) and (B, N, Y′) may be obtained using multiple cost metrics M, N. The cost instances (A, M, X) and (B, M, X′) associated with the cost metric M may be included in a first reordered candidate list sorted based on the respective cost values. Similarly, the cost instances (A, N, Y) and (B, N, Y′) associated with cost metric N may be included in a second reordered candidate list sorted based on the cost values. In a case where X′<Y<X<Y′, the first reordered candidate may include (B, M, X′) and (A, M, X) in that order, and the second reordered candidate may include (A, N, Y) and (B, N, Y′) in that order.

In some implementations, different parts or subsets of the candidate list may be reordered using different cost metrics. For example, the first n candidates in the candidate list may be reordered based on a first cost metric (e.g., SAD), and the remaining candidates may be reordered based on a second cost metric (e.g., MRSAD). For example, odd-position candidates and even-position candidates may be, respectively, reordered using different cost metrics. For example, the odd-position candidates may be reordered using SAD, and the even-position candidates may be reordered using MRSAD.

In some implementations, only a portion of the candidate list may be subjected to reordering based on cost values. For example, the first n candidates in the candidate list may remain fixed without reordering, and only the remaining candidates may be reordered based on at least two cost metrics. For example, only the first n candidates may be reordered based on at least two cost metrics, and the rest of the candidate list may retain a default or predefined order.

At block 350, the method/process 300 may determine (e.g., by the decoder module 124) a chroma prediction for the chroma block based on the at least one reordered candidate list.

In some implementations, the decoder module 124 may determine a prediction mode from the at least one reordered candidate list, and determine a chroma prediction for the chroma block by using the determined prediction modes. In some implementations, the prediction mode may be determined based on a mode index parsed from the video data.

In some implementations, the decoder module 124 may select, from the at least one reordered candidate list, the first cost instance (e.g., the cost instance associated with the lowest template cost), and may determine the prediction mode for determining the chroma prediction, as being corresponding to the selected cost instance.

In some implementations, the decoder module 124 may determine a selected cost metric, from the multiple cost metrics used for generating the at least one reordered candidate list, then determine the chroma prediction for the chroma block based on the at least one reordered candidate list and the selected cost metric. For example, the decoder module 124 may determine a selected cost metric (e.g., M), and then select, from the cost instances (e.g., (A, M, X) and (B, M, X′)) corresponding to the selected cost metric and included in the at least one reordered candidate list, the cost instance (e.g., (B, M, X′)) associated with the lowest template cost (e.g., X′), and determine the prediction mode (e.g., B) for determining the chroma prediction, as being corresponding to the selected cost instance.

In some implementations, a flag or an index may be signaled in the bitstream by the encoder module 114 for indicating a cost metric. The decoder module 124 may parse the flag or the index from the video data to determine, based on the flag or the index, the selected cost metric from the multiple cost metrics used for generating the at least one reordered candidate list. For example, a flag with a value of 0 may indicate a cost metric of SAD, and a flag with a value of 1 may indicate a cost metric of SATD. For example, an index with a value of 0 may indicate a cost metric of SAD, an index with a value of 1 may indicate a cost metric of SATD, and an index with a value of 2 may indicate a cost metric of MR-SAD.

In some implementations, in a case that the candidate list includes both the linear model mode(s) and the non-linear model mode(s), the flag or the index indicating the cost metric may be signaled before the syntaxes for the linear and non-linear model modes. In some implementations, in a case that the candidate list includes, solely, the linear model mode(s), the flag or the index indicating the cost metric may be signaled before the syntax for the linear model mode(s) and after the linear mode flag. In some implementations, in a case that the candidate list includes, solely, the non-linear model mode(s), the flag or the index indicating the cost metric may be signaled before the syntax for the non-linear model mode(s) and after the linear mode flag.

In some implementations, the decoder module 124 may determine two (or more) prediction modes from the at least one reordered candidate list, determine a chroma prediction for the chroma block using each prediction mode, and perform a fusion operation on the determined chroma predictions to obtain a final chroma prediction for the chroma block.

In some implementations, the prediction modes may be determined based on one or more mode index(es) parsed from the video data. For example, a mode index may be used for determining a first prediction mode from a first reordered candidate list, and the same mode index may be used for determining a second prediction mode from a second reordered candidate list. For example, a first mode index may be used for determining a first prediction mode from a reordered candidate list, and a second mode index may be used for determining a second prediction mode from the same reordered candidate list. For example, a first mode index may be used for determining a first prediction mode from a first reordered candidate list, and a second mode index may be used for determining a second prediction mode from a second reordered candidate list.

In some implementations, the decoder module 124 may select, from the at least one reordered candidate list, the first n cost instances (e.g., the cost instances associated with n lowest template costs), and may determine the prediction modes for determining the chroma prediction, as being corresponding to the selected cost instances.

In some implementations, the two (or more) determined prediction modes may be obtained from different reordered candidate lists. For example, a first prediction mode may be obtained from a first reordered candidate list (e.g., that is generated using a first cost metric), and a second prediction mode may be obtained from a second reordered candidate list (e.g., that is generated using a second cost metric).

In some implementations, the decoder module 124 may determine a selected cost metric from the multiple cost metrics used for generating the at least one reordered candidate list, then determine the chroma prediction for the chroma block based on the at least one reordered candidate list and the selected cost metric. For example, the decoder module 124 may determine a selected cost metric (e.g., M), and then select, from the cost instances (e.g., (A, M, X) and (B, M, X′)) corresponding to the selected cost metric and included in the at least one reordered candidate list, the two (or more) cost instances (e.g., (B, M, X′) and (A, M, X)) associated with two lowest template costs (e.g., X′ and X), and determine the prediction modes (e.g., B and A) for determining the chroma prediction, as being corresponding to the selected cost instances. By using a fusion operation, the decoder module 124 may obtain a final chroma prediction for the chroma block based on the determined prediction modes (e.g., B and A).

In some implementations, a flag or an index may be signaled in the bitstream by the encoder module 114 for indicating a cost metric. The decoder module 124 may parse the flag or the index from the video data, to determine, based on the flag or the index, the selected cost metric from the multiple cost metrics used for generating the at least one reordered candidate list. For example, a flag with a value of 0 may indicate a cost metric of SAD, and the flag with a value of 1 may indicate a cost metric of SATD. For example, an index with a value of 0 may indicate a cost metric of SAD, the index with a value of 1 may indicate a cost metric of SATD, and the index with a value of 2 may indicate a cost metric of MR-SAD.

In some implementations, in a case that the candidate list includes both the linear model mode(s) and the non-linear model mode(s), the flag or the index indicating the cost metric may be signaled before the syntaxes for the linear and non-linear model modes. In some implementations, in a case that the candidate list includes solely the linear model mode(s), the flag or the index indicating the cost metric may be signaled before the syntax for the linear model mode(s) and after the linear mode flag. In some implementations, in a case that the candidate list includes solely the non-linear model mode(s), the flag or the index indicating the cost metric may be signaled before the syntax for the non-linear model mode(s) and after the linear mode flag.

At block 360, the method/process 300 may reconstruct (e.g., by the decoder module 124) the chrome block based on the chroma prediction.

In some implementations, the decoder module 124 may add multiple residual components into the prediction block (e.g., the chroma prediction of the chroma block determined at block 350) to reconstruct the chroma block. The residual components may be determined from the bitstream.

Referring back to FIG. 3, once the chroma block is reconstructed, the method/process 300 may then end. By repeating the method/process 300, multiple chroma blocks may be reconstructed and, as a result, the multiple image frames included in the video data may be reconstructed accordingly.

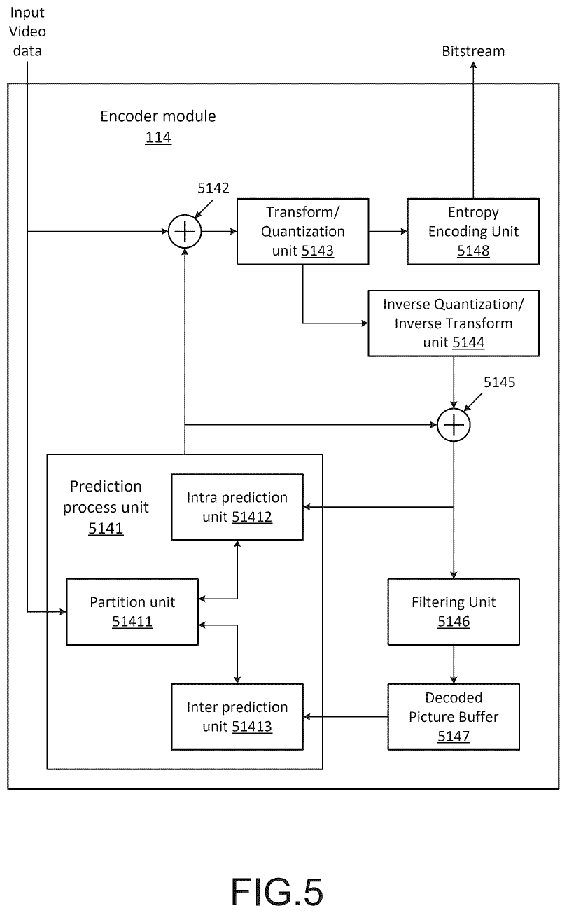

FIG. 5 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 5141), at least a first summer (e.g., a first summer 5142) and a second summer (e.g., a second summer 5145), a transform/quantization processor (e.g., a transform/quantization unit 5143), an inverse quantization/inverse transform processor (e.g., an inverse quantization/inverse transform unit 5144), a filter (e.g., a filtering unit 5146), a decoded picture buffer (e.g., a decoded picture buffer 5147), and an entropy encoder (e.g., an entropy encoding unit 5148). The prediction processing unit 5141 of the encoder module 114 may further include a partition processor (e.g., a partition unit 51411), an intra prediction processor (e.g., an intra prediction unit 51412), and an inter prediction processor (e.g., an inter prediction unit 51413).

The encoder module 114 may receive the source video and encode the source video to output a bitstream. The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 5141 may receive a current image block of a specific one of the image frames. The current image block may be the luminance block or one of the chrominance blocks in the specific image frame.

The partition unit 51411 may divide the current image block into multiple block units. The intra prediction unit 51412 may perform intra-predictive coding of a current block unit relative to one or more neighboring blocks in the same frame as the current block unit in order to provide spatial prediction. The inter prediction unit 51413 may perform inter-predictive coding of the current block unit relative to one or more blocks in one or more reference image blocks to provide temporal prediction.

The prediction processing unit 5141 may select one of the coding results generated by the intra prediction unit 51412 and the inter prediction unit 51413 based on a mode selection method, such as a cost function. The mode selection method may be a rate-distortion optimization (RDO) process.

The prediction processing unit 5141 may determine the selected coding result and provide a predicted block corresponding to the selected coding result to the first summer 5142 for generating a residual block and to the second summer 5145 for reconstructing the encoded block unit. The prediction processing unit 5141 may further provide syntax elements, such as motion vectors, intra-mode indicators, partition information, and/or other syntax information, to the entropy encoding unit 5148.

The intra prediction unit 51412 may intra-predict the current block unit. The intra prediction unit 51412 may determine an intra prediction mode directed toward a reconstructed sample neighboring the current block unit in order to encode the current block unit.

The intra prediction unit 51412 may encode the current block unit using various intra prediction modes. The intra prediction unit 51412 of the prediction processing unit 5141 may select an appropriate intra prediction mode from the selected modes. The intra prediction unit 51412 may encode the current block unit using a cross-component prediction mode to predict one of the two chroma components of the current block unit based on the luma components of the current block unit. The intra prediction unit 51412 may predict a first one of the two chroma components of the current block unit based on the second of the two chroma components of the current block unit.

The inter prediction unit 51413 may inter-predict the current block unit as an alternative to the intra prediction performed by the intra prediction unit 51412. The inter prediction unit 51413 may perform motion estimation to estimate motion of the current block unit for generating a motion vector.

The motion vector may indicate a displacement of the current block unit within the current image block relative to a reference block unit within a reference image block. The inter prediction unit 51413 may receive at least one reference image block stored in the decoded picture buffer 5147 and estimate the motion based on the received reference image blocks to generate the motion vector.

The first summer 5142 may generate the residual block by subtracting the prediction block determined by the prediction processing unit 5141 from the original current block unit. The first summer 5142 may represent the component or components that perform this subtraction.

The transform/quantization unit 5143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 5143 may perform a scan of the matrix including the quantized transform coefficients. Alternatively, the entropy encoding unit 5148 may perform the scan.

The entropy encoding unit 5148 may receive multiple syntax elements from the prediction processing unit 5141 and the transform/quantization unit 5143, including a quantization parameter, transform data, motion vectors, intra modes, partition information, and/or other syntax information. The entropy encoding unit 5148 may encode the syntax elements into the bitstream.

The entropy encoding unit 5148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 5144 may apply inverse quantization and inverse transformation to reconstruct the residual block in the pixel domain for later use as a reference block. The second summer 5145 may add the reconstructed residual block to the prediction block provided by the prediction processing unit 5141 in order to produce a reconstructed block for storage in the decoded picture buffer 5147.

The filtering unit 5146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 5145.

The decoded picture buffer 5147 may be a reference picture memory that stores the reference block to be used by the encoder module 114 to encode video, such as in intra-coding or inter-coding modes. The decoded picture buffer 5147 may include a variety of memory devices, such as DRAM (e.g., including SDRAM), MRAM, RRAM, or other types of memory devices. The decoded picture buffer 5147 may be on-chip with other components of the encoder module 114 or off-chip relative to those components.

The method/process 300 for decoding/encoding video data may be performed by the first electronic device 110. The encoder module 114 may receive the video data. The video data received by the encoder module 114 may be a video. The encoder module 114 may determine a block unit from an image from from according to the video data. The encoder module 114 may divide the image frame to generate multiple CTUs, and further divide one of the CTUs to determine the block unit according to one of multiple partition schemes based on any video coding standard. The block unit may be, for example, a chroma block. Details for determining the chroma block are described above (e.g., as illustrated with block 320 of FIG. 3) and therefore are not repeated herein.

With respect to the chroma block, the encoder module 114 may construct a (chroma) candidate list for the chroma block. The candidate list may include multiple (chroma) prediction modes. Details for constructing the candidate list are described above (e.g., as illustrated with block 330 of FIG. 3) and therefore are not repeated herein.

After construction, the encoder module 114 may generate at least one reordered candidate list based on the candidate list. Specifically, the encoder module 114 may calculate, for each prediction mode in the candidate list, multiple template costs by using multiple cost metrics, to obtain multiple cost instances each corresponding to one of the prediction modes and one of the cost metrics. The encoder module 114 may then include and sort the cost instances into the at least one reordered candidate list. Details for generating the at least one reordered candidate list are described above (e.g., as illustrated with blocks 340, 341, and 343 of FIG. 3) and therefore are not repeated herein.

The encoder module 114 may use the method/process 300 to determine a chroma prediction for the chroma block based on the at least one reordered candidate list, and to further reconstruct the chroma block based on the chroma prediction. The reconstructed chroma block may include multiple reconstructed chroma samples, which may be used as references for predicting subsequent blocks in the video data. The encoder module 114 may also encode one or more syntax elements associated with the chroma prediction (e.g., such as the flag or the index identifying the prediction mode or identifying the cost metric) into the bitstream.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a chroma block from an image frame according to the video data;
construct a candidate list for the chroma block, the candidate list comprising a plurality of prediction modes;
generate at least one reordered candidate list based on the candidate list by:
calculating, for each of the plurality of prediction modes in the candidate list, a plurality of template costs by using a plurality of cost metrics to obtain a plurality of cost instances, each corresponding to one of the plurality of prediction modes and one of the plurality of cost metrics, and
including and sorting the plurality of cost instances in the at least one reordered candidate list;
determine a chroma prediction for the chroma block based on the at least one reordered candidate list; and
reconstruct the chroma block based on the chroma prediction.

2. The electronic device of claim 1, wherein the one or more computer-executable instructions, when executed by the at least one processor, further cause the electronic device to:
determine a selected cost metric from the plurality of cost metrics; and
determine the chroma prediction for the chroma block further based on the selected cost metric.

3. The electronic device of claim 1, wherein the plurality of cost metrics comprises one or more of a sum of absolute difference (SAD), a sum of absolute transformed difference (SATD), a mean removed SAD (MR-SAD), a sum of squared difference (SSD), a structural similarity (SSIM), a mean absolute difference (MAD), and a mean squared difference (MSD).

4. The electronic device of claim 1, wherein the candidate list comprises at least one of a decode derived cross-component prediction (DDCCP) mode and a cross-component prediction (CCP) merge mode.

5. The electronic device of claim 1, wherein the candidate list comprises a most probable mode (MPM) list.

6. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a chroma block from an image frame according to the video data;
construct a candidate list for the chroma block, the candidate list comprising a plurality of prediction modes;
generate at least one reordered candidate list based on the candidate list by:
calculating, for each of the plurality of prediction modes in the candidate list, a plurality of template costs by using a plurality of cost metrics to obtain a plurality of cost instances, each corresponding to one of the plurality of prediction modes and one of the plurality of cost metrics, and
including and sorting the plurality of cost instances in the at least one reordered candidate list;
determine a chroma prediction for the chroma block based on the at least one reordered candidate list; and
reconstruct the chroma block based on the chroma prediction.

7. The electronic device of claim 6, wherein the one or more computer-executable instructions, when executed by the at least one processor, further cause the electronic device to:
determine a selected cost metric from the plurality of cost metrics; and
determine the chroma prediction for the chroma block further based on the selected cost metric.

8. The electronic device of claim 6, wherein the plurality of cost metrics comprises one or more of a sum of absolute difference (SAD), a sum of absolute transformed difference (SATD), a mean removed SAD (MR-SAD), a sum of squared difference (SSD), a structural similarity (SSIM), a mean absolute difference (MAD), and a mean squared difference (MSD).

9. The electronic device of claim 6, wherein the candidate list comprises at least one of a decode derived cross-component prediction (DDCCP) mode and a cross-component prediction (CCP) merge mode.

10. The electronic device of claim 6, wherein the candidate list comprises a most probable mode (MPM) list.

11. A non-transitory machine-readable medium of an electronic device storing one or more computer-executable instructions for decoding video data, the one or more computer-executable instructions, when executed by at least one processor of the electronic device, causing the electronic device to:
receive the video data;
determine a chroma block from an image frame according to the video data;
construct a candidate list for the chroma block, the candidate list comprising a plurality of prediction modes;
generate at least one reordered candidate list based on the candidate list by:
calculating, for each of the plurality of prediction modes in the candidate list, a plurality of template costs by using a plurality of cost metrics to obtain a plurality of cost instances, each corresponding to one of the plurality of prediction modes and one of the plurality of cost metrics, and
including and sorting the plurality of cost instances in the at least one reordered candidate list;
determine a chroma prediction for the chroma block based on the at least one reordered candidate list; and
reconstruct the chroma block based on the chroma prediction.

12. The non-transitory machine-readable medium of claim 11, wherein the one or more computer-executable instructions, when executed by the at least one processor, further cause the electronic device to:
determine a selected cost metric from the plurality of cost metrics; and
determine the chroma prediction for the chroma block further based on the selected cost metric.

13. The non-transitory machine-readable medium of claim 11, wherein the plurality of cost metrics comprises one or more of a sum of absolute difference (SAD), a sum of absolute transformed difference (SATD), a mean removed SAD (MR-SAD), a sum of squared difference (SSD), a structural similarity (SSIM), a mean absolute difference (MAD), and a mean squared difference (MSD).

14. The non-transitory machine-readable medium of claim 11, wherein the candidate list comprises at least one of a decode derived cross-component prediction (DDCCP) mode and a cross-component prediction (CCP) merge mode.

15. The non-transitory machine-readable medium of claim 11, wherein the candidate list comprises a most probable mode (MPM) list.
